(19) United States
(12) Patent Application Publication
(10) Pub. No.: US 2014/0372195 A1
(43) Pub. Date: Dec. 18, 2014

(54) ELECTRONIC REWARD SYSTEM

(71) Applicant: Robert Desideri, Palm Beach, FL (US)

(72) Inventor: Robert Desideri, Palm Beach, FL (US)

(21) Appl. No.: 13/916,198

(22) Filed: Jun. 12, 2013

(51) Int. Cl. G06Q 30/02

(52) U.S. Cl. CPC G06Q 30/0227; G06Q 30/0207; G06Q 30/0225
USPC 705/14.26; 705/14.1; 705/14.28

(57) ABSTRACT

Data is detected from transaction systems, the data including a party's financial inflows, holding, outflows, payables and receivables. Data is also detected from location systems, the data including a party's proximity to a place or further party. Data is processed to determine if a reward should be triggered. Rewards are expressed as an amount of a virtual currency.

### BACKGROUND

The present invention generally relates to electronic commerce.

Businesses struggle to both retain existing customers and acquire new ones. The Internet has enabled businesses to advertise on web pages, create electronic loyalty cards, offer group purchasing coupons and other schemes to extend the reach and breadth of customer retention and acquisition methods. However, customers appear to have tired of clicking on advertisements links, soured of having their chat streams polluted with promoted shout-outs from vendors and become resentful of space-hogging reserved advertisement bars or partitions along the tops and bottoms of smartphone apps crowding out the desired content. In general, individuals are becoming less responsive to online advertising and in many cases avoiding it. And while virtual rewards have recently entered the online vernacular, presenting users with honorific titles and vanity leaderboards purported to be proxies for individuals' importance and or clout, these too are proving inconsequential incentives for encouraging meaningful transactions for advertisers and commerce in general. Online, virtual currencies have been utilized for many years in games, fantasy worlds, retailer promotions, loyalty schemes, earning schemes, promotions and elsewhere. Most frequently virtual currency is purchased or received with a purchase, for example virtual coin spending and flyer miles.

### SUMMARY OF THE INVENTION

The present invention is directed at least in part to overcoming the above and other problems in encouraging commerce, both online and in the physical world.

Everyday life for most involves going to places, purchasing things and sometimes selling things. Some of us have banking accounts, credit cards, wallets and GPS radios on our phones. We purchase things online after shopping around for bargains. We sell old things we don't need in online auctions, we go to restaurants where we pay the checks and tip waiters. With all of this coming and going and transactions our lives are chaotic sometimes. Wouldn't it be nice if there was some reward for all that complexity, a pleasant surprise at the end of the day. Or whenever.

The invention is an electronic location/transaction detection system that provides an indication when a user satisfies at least one proximity criterion and at least one activity-related criterion, also sometimes referred to herein as “triggers.” An object of the invention is to indicate users for rewards. While “just being nice” is one good reason to reward a party, encouraging a party to be active is another. The more places a party goes and the more transactions a party participates in the likelihood of causing a trigger increases. And sometimes certain types of visits or transactions increase the likelihood more.

The proximity trigger may be, for example, being present at a particular location, such as a particular store or any store of a particular store chain; being present at a particular event, such as a sporting event; being on a train; or being proximate to another particular party or type of party, e.g., a doctor. Regarding proximity criteria, a user visiting a physical or virtual store can be verified via, for example, GPS or other geo-location mechanisms running on the consumer's smart phone, detection of the user, for example identity-matching facial recognition or the decoding of an encoded image presented by the user, or detection of a device of the user, detection of identity-proving signals or waves emanating from the user such as for example brain waves, detection of identity-proving bodily material or characteristic, and or presentation of a code by the user, presentation of a secret or an asset to the system by a user who learned or collected it from a web page or physical encounter, for example capture of a QR code displayed on a billboard or electronic screen or a phrase or photo or in communication with another party.

The transactional trigger may be, for example, purchasing a particular product or type of product; gifting an amount of value which could be virtual currency to another party; or keeping a balance or balances of at least a certain amount of fiat or virtual currency in an account or accounts over a specified period of time. Other examples are deposit by a user of an unemployment check from a department of labor, or purchase of a sports car on a credit card.

The at least one proximity-related criterion and the at least one activity-related criterion may be related or coincide in time or place. However, this is not a requirement. For example the at least one geographical criterion may be that the user is at, or perhaps attended within a first time frame, a baseball game and the at least one activity-related criterion may be that the user purchased beer at a bar within a second time frame which is not necessarily the same as the first time frame—or may be.

In particular possible uses of the system, a user may be given a reward when the triggers are satisfied. In particular other uses of the system, the fact that the two or more particular triggers occurred, at least one of each of the two types, may serve as the basis for determining the content of electronic advertising targeted at that particular user with or without a reward.

The criterion for triggering may precede or be post proximity and or activity occurrences that may contribute to triggering. Said another way, criterion established today may be formulated to look back historically for certain proximity and activity data or may be formulated with forward-looking parameters.

Consider the use of the location/transaction detection system in connection with the awarding of rewards. Specifically, rewards are realized serendipitously by a user when triggers are fulfilled inadvertently by users without awareness of either or both of the criterion or “triggers.” Alternatively one or both of the triggers may be disclosed in part or in full, or as hint narratives, by the system to one or more users, thereby opening the possibility of encouraging or inducing users to actively pursue the reward. The awarding of rewards may be accompanied by revelation of the underlying triggers in an effort to encourage a particular behavior. So in the previous baseball game example, let us assume that the user is unaware that being at the baseball game or that having purchased a beer within the previous day are reward triggers. The system determines a) the user's presence at the ballpark via real-time or historical GPS data collected by the user's device or otherwise and b) that beer was purchased the previous day via, for example, linkage to credit card purchase history or otherwise.

Using a proximity/transaction detection data as a way of determining when rewards are to be awarded also works to stimulate behavioral change in the user—as well as benefiting subsequent reward-receiving parties—in situations where it is desirable to encourage a user to be in, or to go to, a particular location at a particular time, such as the “Grand Opening” of a new store. The inventive approach also encourages certain activities, such as the user being a party to a transaction or snapping a photograph or even digging a ditch for a further party. The activity—for example digging a ditch—may coincidentally produce compensation for the user as a component of the transaction. (Such compensation is not to be confused with the reward). The compensation may be, for example, payment in a fiat currency, financial credit, virtual currency or a chit representing, for example, a credit for an hour of the user's work.

The reward may be in the form of a virtual currency. The awarded virtual currency may be stored, for example, in a electronic wallet system maintained in a consumer's computer or smartphone or it may be stored in the cloud. Recipients of the virtual currency may include parties who are potential or existing consumers of further parties who transact with their customers, clients or others utilizing electronic commerce systems.

The detection of activity and the detection of proximity as well as the other aspects of the system as described herein are all carried out in large part by computers and mobile devices communicating electronically via the web and mobile or various other communications networks.

The use of the location/transaction detection system to award rewards may advantageously be carried out in conjunction with a looped incentive commerce system of the type disclosed in my co-pending patent application filed of even date herewith, Ser. No. ______ and entitled “Looped Incentive Commerce System.”

The details of one or more implementations of the invention are set forth in the accompanying drawings and the description below. Other features, objects, and advantages of the invention will be apparent from the description and drawings, and from the claims.

### BRIEF DESCRIPTION OF THE DRAWINGS

A more complete understanding of the invention may be derived by referring to the detailed description and claims when considering in connection with the Figures, wherein like reference numbers refer to similar elements throughout the Figures, and

FIG. 1 shows a conceptual simplified diagram wherein a rewards is indicated;

FIG. 2 shows a conceptual arrangement embodying the principles of the invention;

FIG. 3 is a reward distribution example for a single user;

FIG. 4 is a simplified example of reward-determining data;

FIG. 5 depicts a wallet conceptual illustration;

FIG. 6 depicts an advertisements conceptual illustration.

### DETAILED DESCRIPTION

The present disclosure describes aspects of embodiments of a system and method for determining when a reward should be issued to a party. More specifically, a party who “visits locations” and also “transacts”.

Herein we use “proximity” to mean locations, whether specific or relative to an object, other party, event or other entity. Herein we use “activity” to mean transacting or moving holding value, for example purchasing or selling, maintaining a balance or similar activities.

The present invention is described in detail herein. In an embodiment of the invention enrolled parties, members (sometimes herein called “users”, “parties” or “member transactors”) are “indicated” or “flagged” to receive rewards. A criteria relating to both a proximity and an activity, with proximity data and activity data of members are evaluated to determine reward indication for a member.

In this disclosure for exemplary purposes the reward is referred to as a “native virtual currency”. My co-pending patent application filed of even date herewith entitled “Looped Incentive Commerce System” distributes rewards, in an embodiment the invention of my co-pending patent application utilizes the method and system of the present invention, disclosed herein. Drawings disclosed herein may include aspects of a looped incentive commerce system make it more easily understood how the present invention is both novel and utilized in an exemplary context.

“Virtual wallets” or “e-wallets”, herein referred to as “wallets” or “wallet apps”, meaning software that run on electronic computing devices used for transacting. Wallets may also be hardware, though more typical today are software applications running on electronic devices such as smartphones, tablets and notebook and desktop computers. Wallets, in a preferred embodiment, as a source of both proximity data and activity data, proximity data captured from GPS radios on smartphones running wallet apps and activity data captured from financial transactions performed by the wallet and from and financial accounts linked to wallets.

In this description, reference will be made to the appended drawings, in which:

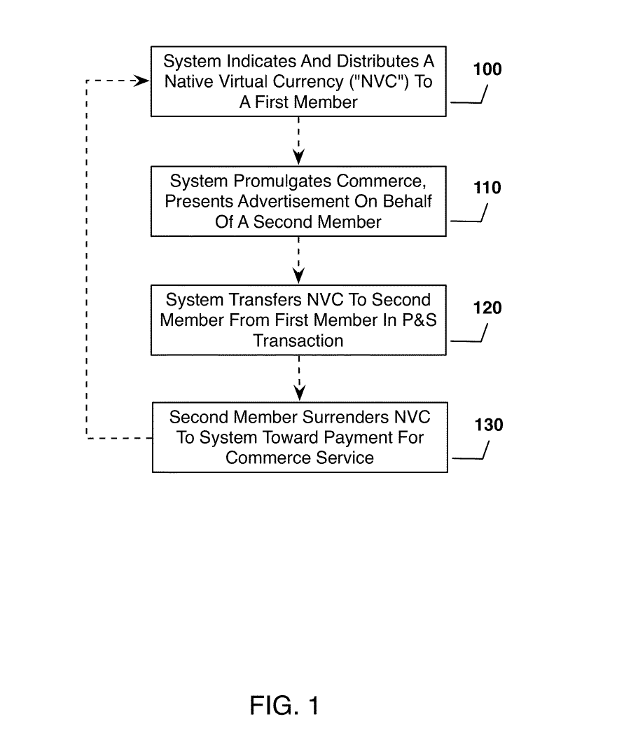

FIG. 1 is included to suggest a context where the present invention indicates a reward is indicated 100 for a party. Steps 110; 120; 130 are shown solely for context, they have no bearing on the present invention.

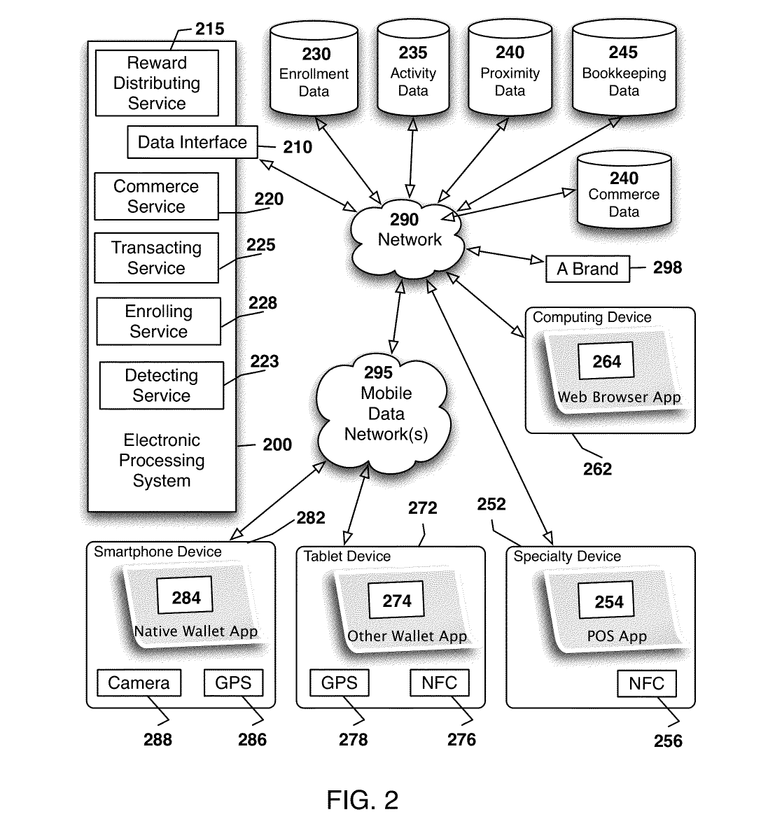

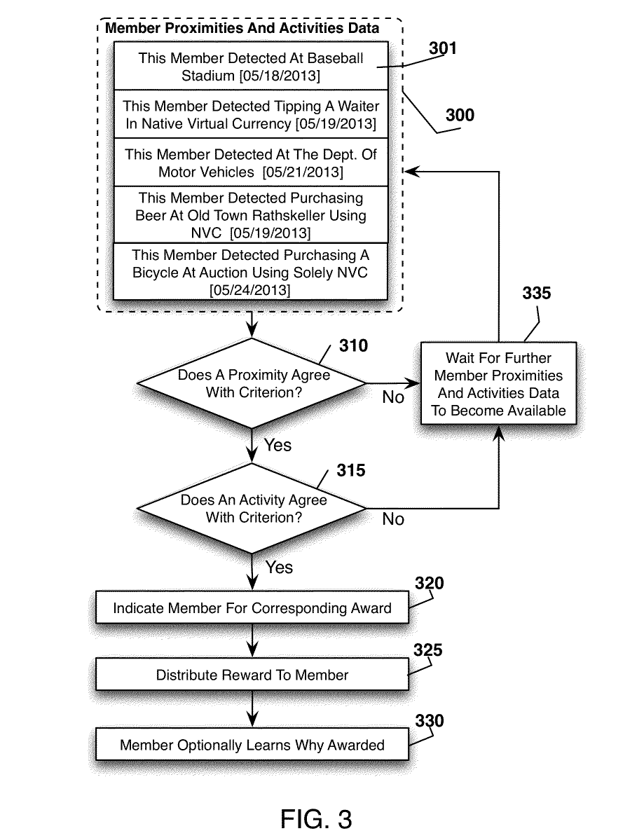

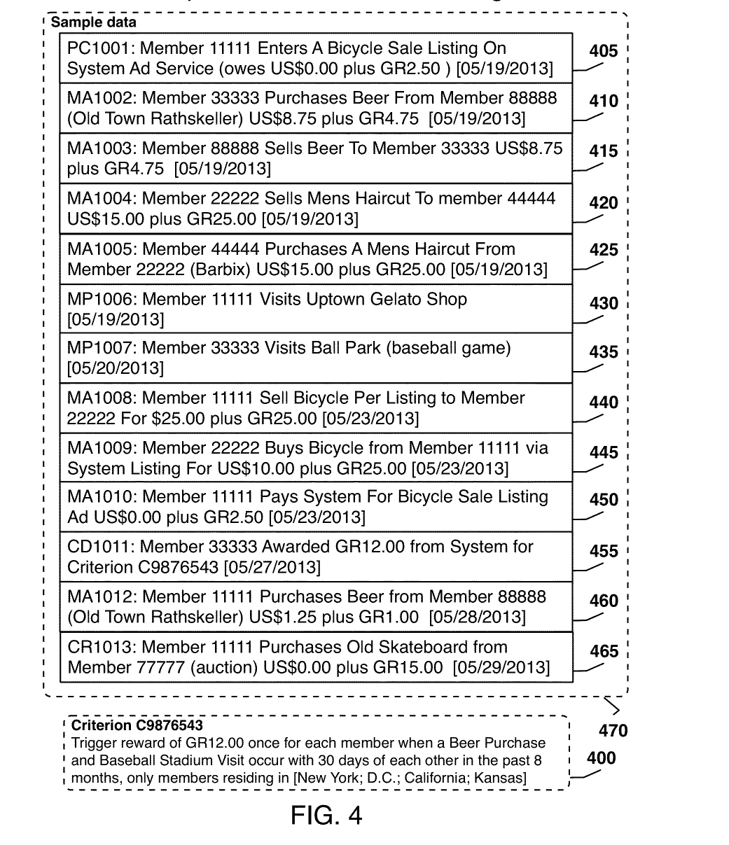

FIG. 2 shows a conceptual arrangement where the present invention is utilized by a reward distribution service 215 running on an electronic processing system 200. In a preferred embodiment wallet apps 274; 285, as mentioned earlier, are a resource for collecting proximity and activity data, as would be stored in a proximity database 240 and activity database 235. It is anticipated that proximity data may also be from or derived from data collected by devices other than smartphone, for example cameras, facial detection software, RFID and other types of detectors, token collectors, card readers, checkpoint readers, loggers, brainwave signal receiver, receivers and biometric sensors also communicate with the system's services, for example to detect and or report member proximity to the system and collect further data. Illustrative examples of activity data are interspersed in FIG. 3 300 and FIG. 4 470.

Identifying members is via enrollment data 230, which may have been originated by an enrollment service 228, for example when a member voluntarily “joins” and or detected 223 from one or more databases, for example databases of a partner financial services company, mobile telephone company, agency. In a preferred embodiment enrollment is performed via a sign-up page in a wallet app 284; 274, on a web page in a web browser 264, or in a page in a point of sale app 254, or via other electronic data entry methods.

FIG. 3 shows an example for how an arrangement of the invention indicates a reward 320 for a member and distributes said reward 235 as well as optionally enables the member to learn 330 some or all of the reasoning the reward was distributed. Learning reasoning is potentially a behavioral assistance tool for encouraging members to extrapolate for future rewards, generally, activities and proximities that might be good for helping in receiving pleasantly surprising rewards. For example, if tipping waiters using native virtual currency frequently triggers a reward the member might do more of it. When a member's proximity and activity data 300 does not satisfy both the proximity test 310 and activity test 315 the system awaits further data 335, at which point it again attempts to determine if the member is due a reward. For example, new activity data may arrive comprising the fact that this member tipped a waiter on May 25, 2013, said new activity data may satisfy the activity criterion 315 where the proximity criterion is satisfied 310 by having been detected in a baseball stadium 301 on May 18, 2013, the criterion may have included a requirement that the occurrence of both the stadium proximity and the tipping activity be within 30 days of each other, as it is in this example.

FIG. 4 shows an example of reward-determining data 470, including an example of how a criterion 440, expressed in plain English, may appear. The example in FIG. 300 shows data for one hypothetical member, FIG. 4 shows data for several hypothetical members. This example helps visualize what the system accomplishes—promulgating and stimulating commerce utilizing an incentive loop. For example, commerce is specifically promulgated on behalf of member 11111 via an advertisement 405 for a bicycle, said member compensating the system for said advertisement 450 in this example using solely native virtual currency. Said payment in other example may be in a mix of real money plus native virtual currency. Data in any of the exemplary records 405; 410; 415; 420; 425; 430; 435; 440; 445; 450; 455; 460; 465 could contribute triggering a reward.

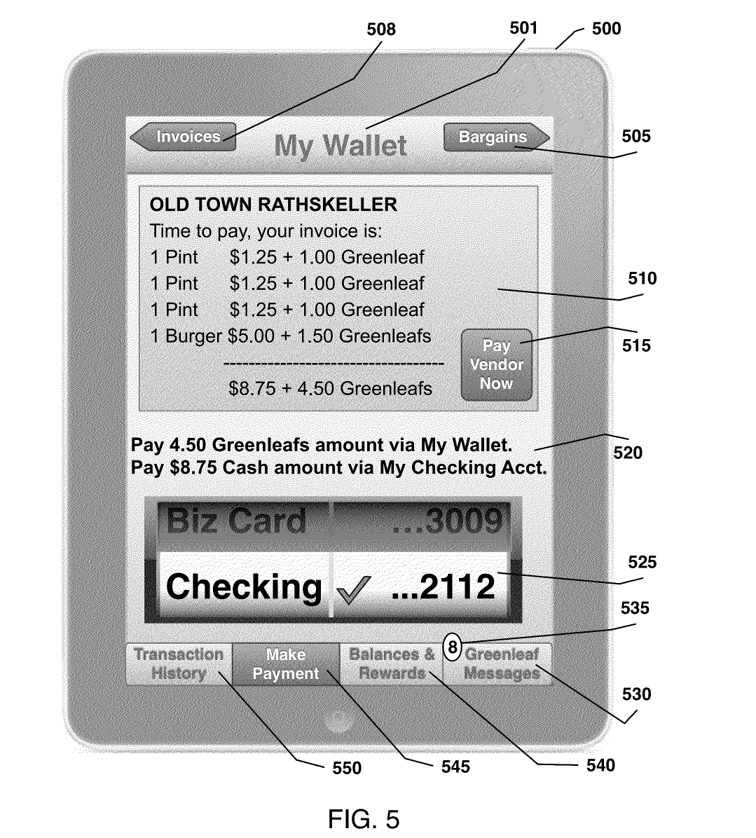

FIG. 5. is a conceptual illustration of a member's wallet app 501 running on a portable computing device 500, a tablet device, connected to the Internet. On one example the member's wallet app, let's identify the member as Member 88888, is about to pay his invoice (sometimes also known as a “check” or “bill”) at a gastropub. Said invoice presents the amount owed, it is mixed, Member 88888 owes US$8.75 and 4.50 Greenleafs 510, a Greenleaf being the moniker of a native virtual currency for this example. Returning to FIG. 4 briefly, a corresponding exemplary record 415 showing Member 88888 pays a further Member 33333, the gastropub Old Town Rathskeller. A further record shows Member 33333 is shown receiving said payment 410. While wallets are not required for the present invention to be build or operated, in a preferred embodiment wallets are utilized and provide a source of proximity data and activity data.

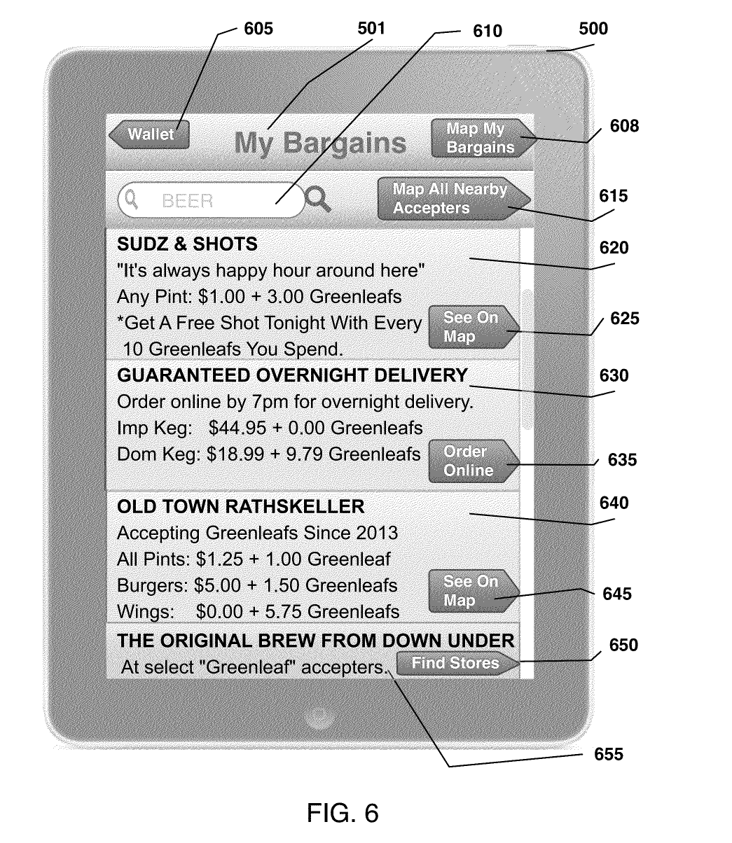

FIG. 6 is a conceptual illustration of a bargain interface 501 in a wallet app. In a preferred embodiment bargains for online shopping comprise links to websites, when a user “visits” a website that visit becomes proximity data for said member.

Members transacting with members, for example a party selling a used bicycle to a neighbor, is transaction data as is a purchase from a store on main street or a purchase in an online store. Selling a good or service is transaction data.

In FIG. 2 a reward distributing service 215 generally performs rewards related functionality, for example handling criteria, determining if a reward should be distributed and reward size, notifying members, updating a centralized or distributed database 245 to reflect the transactions. The present invention may be implemented “stand alone” or, as in this example within other services.

Continuing, detecting service 223 generally accesses feeds, databases and other resources for the system to learn of member proximity and activity, for example if a user has been in a ballpark or a pub, has purchased beer and or specific brand of beer, donated to a charity or a specific charity, tipped a hospitality worker, sold three hours of coding service, held an average balance in a banking account for a determined period and other such proximity and action data, as illustrated conceptually by an activity database 235 and a proximity database 240.

In the bicycle seller example FIG. 4 we briefly visited earlier we now shall delve into more detail. Let's assume the transaction had a non-native virtual currency component of US$10.00 and native virtual currency component of 25.00 units, we'll again refer a native virtual currency by a made up moniker—“Greenleafs”—in this example. The seller now having a further 25.00 Greenleafs in her account pays the system for the commerce promulgating service 110, the advertisement she placed for the bicycle. The system in this example charges 2.50 Greenleafs for a bicycle advertisement. In this example is no US$ amount for bicycle ads, though for other services, for example selling a haircut there could be both a native virtual currency amount and a US$ amount. In the preferred embodiment the system may be configured to only accept a specific mix or leave it up to the payer to decide the mix, for example the system may proffer delivering an ad for US$1.00 and 2.00 Greenleafs, or is may command 2.50 Greenleafs and no dollars, or it may command US$3.00, leaving it up to the advertiser to decide which to choose.

Returning to FIG. 2 and FIG. 3, let us traverse the distribution process again from beginning to end with a further example. A member's proximity and activity data 300 is detected 223, in this example the member is detected at a ballpark 301 which may have been learned by the system using facial recognition of a photo in a timeline on a social network account. Of course it needn't have been facial recognition from a photo, it could have been detecting the member using a key card or fob to prove his identity when entering the ballpark or selecting a seat, or even fingerprint or retina recognition, DNA recognition or other biometric identifying methods. The system is agnostic as to the method and the resource the system builder chooses, just so long as detection is operable. In the case of activity data, feeds and or connections to financial services records are generally the resource, though cash transactions may be captured manually or for example by capturing a code from a cash purchase receipt, banking or automated teller receipt or other capture method. When a member's proximity data agrees with a criterion 310 and the member's activity data agrees with a criterion 315 the member is deemed by a reward distribution service 215 as being due the reward, said service credits the reward to the member, a bookkeeping entry. The reward may be an exact amount of a native virtual currency as specified within the criterion or otherwise linked to the criterion or it may be a calculated amount of native virtual currency, the invention may be configured for either or both methods.

In a further example, criteria may deem a reward is due for distribution to a member meeting a banking and a “house or worship” criteria, for example the activity criterion being a member having maintained a minimum average monetary balance for 10 days in an account known to the member's virtual wallet and for also meeting the criterion of having been detected in a house of worship thrice within the past 365 days. The native virtual currency could be a fixed amount, for example 3.00 Greenleafs or be a function of the average balance, calculated similarly perhaps to how interest on a real money deposit in a bank is performed.

An important aspect of the invention is that criteria may be different for different groups or individual members claim 8. For example, the banking/worshiping criteria in the example above may have been deployed for a specific or algorithmically specified subset of members, the subset possibly as small as just one member.

Reward systems in the past have, problematically, required recipients to perform directed work or to participate in a directed purchase. Notably, the invention solves these problems, creating the pleasurable experience of a reward without requiring the recipient to pay attention to an advertisement, respond to a survey, go to a directed location, pay for something, send something to a friend, disclose private information, collect pieces, harvest a virtual crop, purchase non-existent virtual goods or otherwise surrender value or time.

Most agree receiving rewards, whether a surprise or not, is a pleasant experience. Rewards also sometimes help shape behavior, which explains why promoters utilize reward miles, loyalty cards and other such schemes. The present invention introduces onto the landscape a novel means for indicating parties for rewards in a time where the chaos of our busy lives may seem overwhelming, our own personal chaos helping us be rewarded. Something as simple as being in the right place and transacting the right thing, causing a little bit of happiness. Serendipitous to the recipient, perhaps less serendipitous to the party configuring proximity criterion and activity criterion for the invention.

The above description and the drawings are merely intended for use as explanation of the invention and must by no means be construed as being limitative to the scope of the invention. All of the foregoing merely illustrates the principles of the invention and numerous alternatives are possible. The sequences of steps presented should be understood to limit the invention to that same sequence, the system may be built and operated with other sequences and or by combining steps or splitting steps into further steps. The specification and drawings are, accordingly, to be regarded in an illustrative sense for explanation of aspects of the disclosed subject matter rather than a restrictive or limiting sense. Practitioners will appreciate that there are a number of ways to implement the principles of the invention using various alternative arrangements not explicitly shown or described herein while still being within the invention's spirit and scope.

1. A method performed by an electronic processing system, the method comprising:
electronically storing information defining at least first and second criteria that must be satisfied by a user in order for a reward to be awarded,
(i) the first criterion being that the user is at or has visited, or is or was within a predetermined proximity of, at least one of a) a specified physical or virtual location, b) a physical or virtual location meeting a specified criterion, c) a specified individual or d) an individual meeting a specified criterion, e) an event or type of event, and
(ii) the second criterion being that the user has participated in at least one activity, the at least one activity being one of (a) the user has surrendered value to, or received value from, another party or category of party (b) the user has been a party to a transaction with a particular party or category of party, (c) the user has conferred a benefit on another party or account balance criterion, or e) the user complied with a request benefiting another party or category of party,
and,
generating an electronic reward indication in response to a wholly-electronic determination that at least both the first and the second criteria have been satisfied.

2. The method of claim 1 wherein either or both of the at least first and second criteria are selected or specified using machine learning or artificial intelligence algorithms.

3. The method of claim 1 wherein either or both of the at least first and second criteria are selected or specified by an administrative party.

4. The method of claim 1 wherein either or both of the at least first and second criteria are selected or specified by a promoter party.

5. The method of claim 1 wherein the activity criterion never includes a compulsory purchase where said promoter party of claim 4 is the beneficial vendor party in said purchase.

6. The method of claim 1 wherein the activity criterion never includes performance of a compulsory purchase transaction by the user for being awarded a reward where the system or the prompter party of claim 4 who selected or specified a first or second criteria is the direct beneficial vendor in said compulsory purchase transaction.

7. The method of claim 1 wherein an indicated reward is in the form of reward currency.

8. The method of claim 6 wherein the reward currency is at least one of a) a coupon redeemable for at least a portion of the purchase price of particular products or services, b) a coupon redeemable for at least a portion of the purchase price of products or services offered by a particular party, c) virtual currency, d) scrip, e) note, f) a promise from a party to provide future value to the awarded party.

9. The method of claim 1 wherein the wholly-electronic determination that the first criterion is satisfied is made using at least one of a) satellite-based positioning system derived coordinates data, b) mobile or other communications system coordinates derived data, c) data from a sensing, recognition or other detecting system, d) a proof of presence.

10. The method of claim 1 wherein the virtual location is an on-line destination.

11. The method of claim 1 wherein either or both criterion further includes a number-of-times requirement.

12. The method of claim 1 wherein either or both criterion further includes a number-of-times-within-a-timeframe requirement.

13. The method of claim 1 wherein the electronic surrendering is a selected one of a) incurring a charge in a credit account, b) incurring a charge in a non-credit account, c) surrendering virtual currency, d) surrendering non-virtual currency.

14. The method of claim 1 wherein the reward currency is not indicated for the user, even though the first and second criteria have been satisfied, in response to a wholly-electronic determination that at least one particular award-negating event has occurred.

15. The method of claim 14 wherein the at least one award-negating event is that the user has participated in or not participated in a specified activity within a specified period of time.

16. The method of claim 14 wherein the at least one award-negating event is that the user has been proximate to in or not proximate to a specified location or party within a specified period of time.

17. An electronic processing system including one or more processors and adapted to execute programming that
electronically stores information defining at least first and second criteria that must be satisfied by a user in order for the reward to be awarded,
(i) the first criterion being that the user must visit, or be within a predetermined proximity of, at least one of a) a specified physical or virtual location, b) a physical or virtual location meeting a specified criterion, c) a specified individual or d) an individual meeting a specified criterion, e) an event, and
(ii) the second criterion being that the user has participated in at least one activity, the at least one activity being one of (a) the user has surrendered value to, or received value from, another party or category of party (b) the user has been a party to a transaction with a particular party or category of party, (c) the user has conferred a benefit on specified account balance criterion, or e) the user complied with a request benefiting another party or category of party,
and,
generates an electronic indication in response to a wholly-electronic determination that at least both the first and the second criteria have been satisfied.
